(19) United States
(12) Patent Application Publication
(10) Pub. No.: US 2011/0232996 A1
(43) Pub. Date: Sep. 29, 2011

(54) Special Ladder Hook Device

(76) Inventor: Frank T. Hull, Pendleton, IN (US)

(21) Appl. No.: 13/073,903

(22) Filed: Mar. 28, 2011

Related U.S. Application Data
(60) Provisional application No. 61/318,381, filed on Mar. 28, 2010.

(51) Int. Cl. E06C 7/14

(52) U.S. Cl. 182/129

(57) ABSTRACT

A ladder hook device developed and designed to provide a unique combination that is specifically self leveling. The device may be used with an extension or step ladder for a temporary means to provide a ladder hook device which can be easily and quickly put in place onto a ladder for use in securing buckets of paint and other materials, then quickly removed at the finish of the work. It is comprised of a hooking means with features made of a durable, flat and flexible material and having a front and a rear surface and a means to connect and secure the device to a ladder for use with a bucket or the like.

### CROSS-REFERENCE TO RELATED APPLICATIONS

This application claims the benefit of Provisional Patent Application Ser. No. 61/318,381 filed Mar. 28, 2010 by Frank T. Hull and entitled Special Ladder Hook Device.

### FIELD OF INVENTION

This invention relates to a Special ladder hook device. Particularly this new device is related to devices and methods to hold provide a bucket or similar mass where painting, cleaning, construction or other work is being temporarily performed. This Special ladder hook device is a new combination of existing materials configured with unique features that provide an effective, practical and economical way to provide a ladder hook device for a working area. The preferred and alternative embodiments are described below.

### FEDERALLY SPONSORED RESEARCH

None.

### SEQUENCE LISTING OR PROGRAM

None.

### BACKGROUND

### Field of Invention and Prior Art

In the construction, home improvement and residential and commercial painting industry, statistics show that there are diverse and expanding markets for various special ladder hook devices. The industries all cater to both professional and hobby activists that need safe and high quality tool devices. Industry indicators show the need for ladder accessories in these industries all support new and safer devices to be utilized as a ladder hook in the U.S. economy.

### A. Introduction of the Problems Addressed

When one is using an extension ladder and similar devices, it is often difficult to find devices that are simple, effective and safe to use for hanging objects from when using the ladder. The Special Ladder Hook Device overcomes many of the existing limitations and provides a simple device to permit efficient hanging objects such as materials and tools from an extension ladder. The particular combinations of materials and features are unique and novel and are not anticipated by prior art. Likewise, use of a Special Ladder Hook Device provides significant benefits compared to prior art ladder hanging devices.

### B. Prior Art

The historical technology focused mainly on bucket holders and complex holders that easily tipped over or made the ladder and user off-balanced. Examples of prior devices begin with U.S. Pat. No. 802,861 issued to Hetherington (1905) and entitled “Paint Bucket Attachment”. This invention teaches a full bucket holder on one side with a hook over the side rail and rung. The device permits easy tipping and does not afford the tool or material (such as a bucket of paint) to seek an equilibrium point as does the Special Ladder Hook Device. Another device was shown by Bogut in U.S. Pat. No. 2,453,189 (1945) entitled “Pot Suspension Device”. A simple hook device was taught but it was comprised also of a chain and closed hook. The device presents opportunities for the chain portion to catch and spill the material or tools and the closed hook complicates the hanging and removing a load as compared to the simplistic Special Ladder Hook Device

A further and more recent example of a hanger device is shown by Lunden, Jr. in U.S. Pat. No. 4,523,733 (1985) and entitled “ladder attachment for use by painters”. This teaches a side caddy device that appears more apt to tipping and spilling when compared to the self-leveling Special Ladder Hook Device. Another concept is shown by Brown in U.S. Pat. No. 4,6702,446 (1987) and entitled “Ladder Caddy”. It displays a bucket only holder using a rung insert. Its multiple and numerous parts are more complex than the Hull device of this invention.

Another mechanism is described in U.S. Pat. No. 5,031,723 issued to Hooten (1991) and entitled “ladder accessories”. This device shows a complex brush, pan and bucket holder that appears very involved to lock the device to the ladder. It also protrudes out from the ladder's side and appears likely to present a tipping probable as compared with the self leveling Special Ladder Hook Device presented here by Hull. A device by Martin in U.S. Pat. No. 5,649,682 (1997) is entitled “simplified container holder for a ladder with hollow rungs”. It strictly holds a bucket and is not nearly as versatile or balanced as the Special Ladder Hook Device.

A later device is shown by Brophy in U.S. Pat. No. 5,797,571 (1998) and is entitled “combined ladder hook and bracket assembly”. This demonstrates complex device that crosses at least to rungs and appears prone to easy tipping of the bucket. It uses the external portion of the rungs and not the inner aperture as the Special Ladder Hook Device.

Finally a patent is shown by Weaver in U.S. Pat. No. 5,934,632 (1999) and entitled “utility can holder for use with hollow rung ladder”. The device teaches a long shaft the is interposed inside the rung and the locked at the end opposite to the bucket holding “encircling” structure. The device is mainly for paint buckets, utility cans and the like and does not self level like the Special Ladder Hook Device taught by the invention of Hull.

As far as known, there are no other Special ladder hook devices at the present time which fully provide these improvements and functional characteristics as the present Special ladder hook device. It is believed that this device is made with fewer parts with improved configurations and physical features to provide more functionality when compared to other currently utilized ladder hook device devices. The particular combinations of materials and features are unique and novel and are not anticipated by prior art. Likewise, use of a Special ladder hook device provides significant benefits compared to prior art devices.

### SUMMARY OF THE INVENTION

A Special ladder hook device has been developed and designed to provide a unique combination that is specifically related to devices and methods to provide a ladder hook device and the like. The Special ladder hook device may be used with an extension or step ladder for a temporary means to provide a self-leveling ladder hook device which can be easily and quickly put in place onto a ladder for use in securing buckets of paint and other materials, then quickly removed at the finish of the work. The benefits are delineated below.

The preferred embodiment of the Special ladder hook device is comprised of a hooking means with features made of a durable, flat and flexible material and having a front and a rear surface. And a means to connect and secure the device to a ladder for use with a bucket or the like. An alternative securement means could be a radiused hook device to mechanically support the hanging bucket or the like to the ladder structure.

### OBJECTS AND ADVANTAGES

There are several objects and advantages of the Special ladder hook device. There are currently no known Special ladder hook devices or other tool and auxiliary devices that are effective at providing the objects of this invention.

The following TABLE A summarizes various advantages and objects of the Special ladder hook device. This list is exemplary and not limiting to the many advantages offered by this new device.

TABLE A
Various Benefits, Advantages and Objects
This device:

| ITEM | BENEFIT |
|---|---|
| 1. | Reduces risk of spillage through a securement means. |
| | Is self-leveling and permits the load to reach a |
| | point of equilibrium an non-tipping. |
| 2. | May be both installed and removed quickly |
| 3. | May be manufactured with existing processes and |
| | equipment |
| 4. | May be stored in small area |
| 5. | Is adaptable to various lengths |
| 6. | Is easy to package and transport |
| 7. | Can be sold and distributed retail, wholesale, or |
| | E-commerce internet sales from a website |
| 8. | May have various messages, legends or languages on |
| | surface |

Noteworthy is that other advantages and additional features of the present Special ladder hook device will be more apparent from the accompanying drawings and from the full description of the device. For one skilled in the art of auxiliary ladder devices to improve material presentation for work areas, it is readily understood that the features shown in the examples with this device is readily adapted for improvement to other types of mechanisms and devices for use as a material presentation device or method.

### DESCRIPTION OF THE DRAWINGS

### Figures

The accompanying drawings, which are incorporated in and constitute a part of this specification, illustrate a preferred and alternative embodiments for the Special ladder hook device. The drawings together with the summary description given above and a detailed description given below serve to explain the principles of the Special ladder hook device. It is understood, however, that the device is not limited to only the precise arrangements and instrumentalities shown.

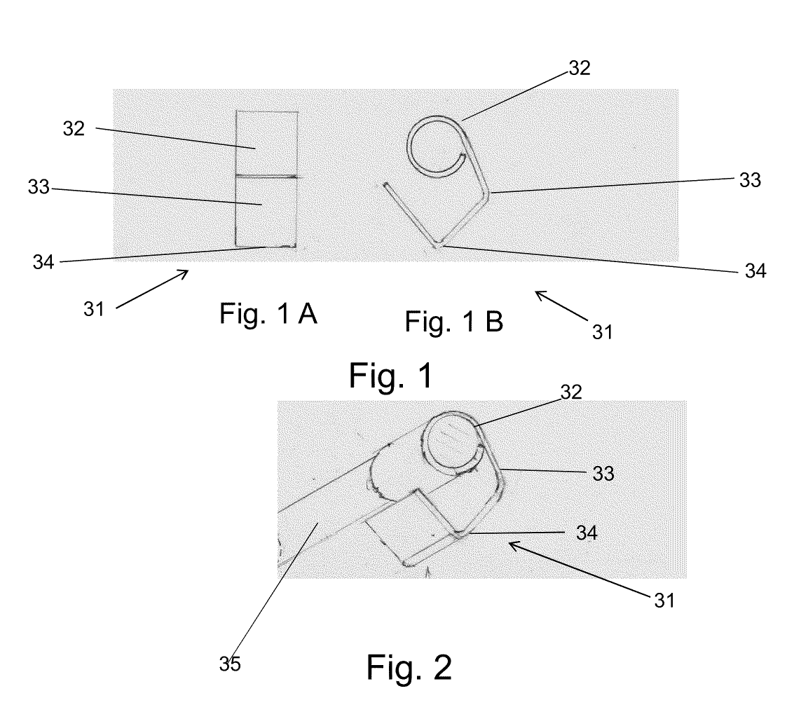

FIGS. 1 A and 1 B are the general views of the actual device—the Special ladder hook device, the device securing a bucket or the like to a ladder device.

FIG. 2 is an isometric sketch of the device with features and components identified.

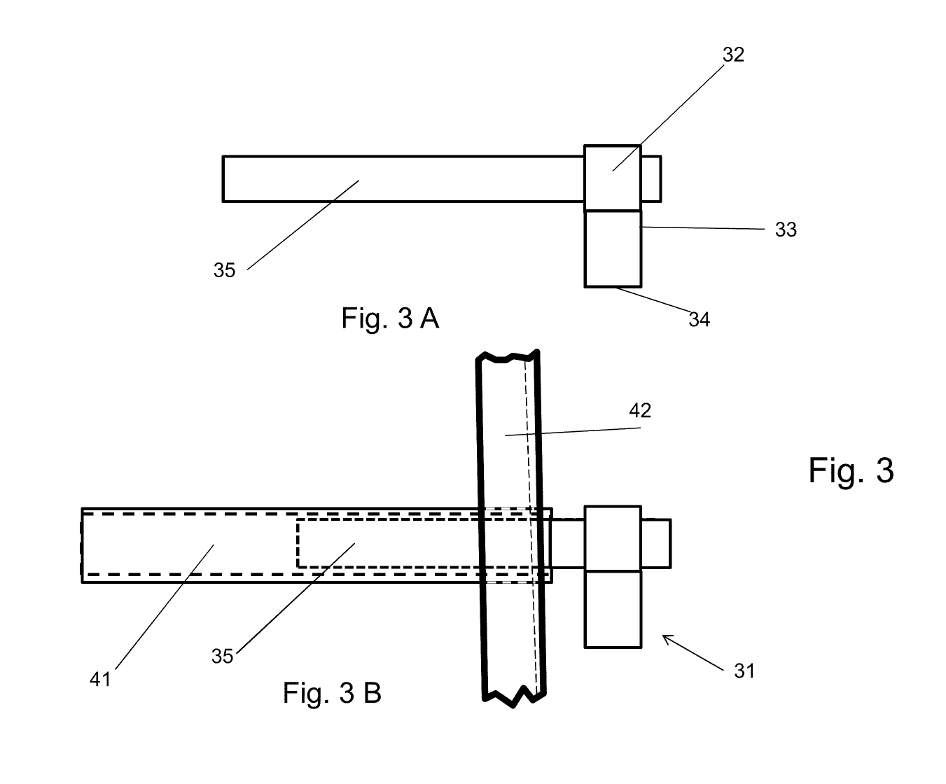

FIGS. 3 A and 3 B are sketches of the device and its insertion into the ladder.

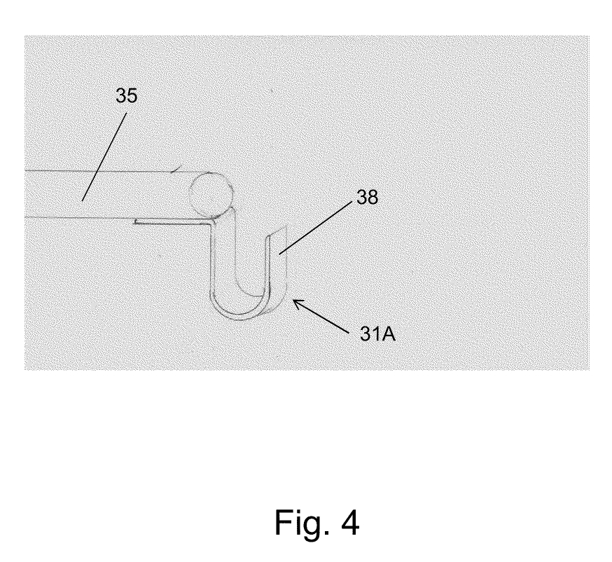

FIG. 4 is an alternative embodiment of the Special ladder hook device.

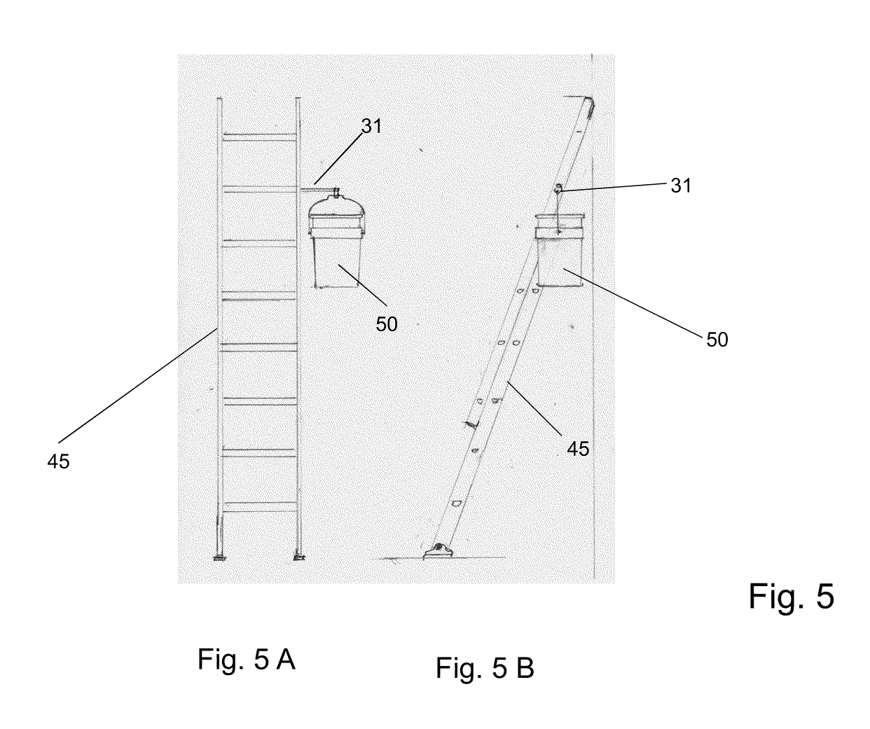

FIGS. 5 A and 5 B are operational views of the Special ladder hook device with the ladder.

### DESCRIPTION OF THE DRAWINGS

### Reference Numerals

The following list refers to the drawings:

TABLE B
Reference numbers

| Ref # | Description |
|---|---|
| 31 | Special ladder hook device |
| 31A | Alternative embodiment with a radiussed hook device 38 |
| 32 | Encircling section of the hook device |
| 33 | Extension structure from the encircling section to the |
| | hanging section |
| 34 | Securement vee or section to secure the hanging object |
| 35 | Extension means to be interior to the ladder rung |
| 38 | Alternative radiussed component secure to the end of |
| | the hook device 31A |
| 41 | Ladder Rung with an aperture |
| 42 | Side rail for the ladder device |
| 45 | Ladder structure |
| 51 | Bucket or the like |

### DETAILED DESCRIPTION OF PREFERRED EMBODIMENT

The present invention is a Special ladder hook device 31. Particularly the preferred embodiment of the Special ladder hook device 31 is related to devices and methods that provide a unique combination of materials with features which have been specifically configured to provide a means or method to support a bucket or the like in conjunction with a ladder. The preferred embodiment of the Special ladder hook device is comprised of a hooking means with features made of a durable, flat and flexible material and having a front and a rear surface. And a means to connect and secure the device to a ladder for use with a bucket or the like. An alternative securement means could be a radiused hook device to mechanically support the hanging bucket or the like to the ladder structure.

There is shown in FIGS. 1 through 5 a complete detail and operative embodiment of the Special ladder hook device 31. In the drawings and illustrations, one notes well that the FIGS. 1 A and 1 B, FIG. 2, and FIG. 3 A details the special configuration. FIG. 4 shows an alternative embodiment. FIG. 3 B and FIGS. 5 A and 5 B show the operative use of this invention. The operation of the Special ladder hook device 31 is discussed below in the Operations section.

The advantages for the Special ladder hook device 31 are listed above in the introduction. Succinctly the benefits are that the device:
Reduces risk of spillage through a securement means. Is self-leveling and permits the load to reach a point of equilibrium an non-tipping.
May be both installed and removed quickly
May be manufactured with existing processes and equipment
May be stored in small area
Is adaptable to various lengths
Is easy to package and transport
Can be sold and distributed retail, wholesale, or E-commerce internet sales from a website
May have various messages, legends or languages on surface

The preferred embodiment of the Special ladder hook device is comprised of a hooking means with features made of a durable, flat and flexible material and having a front and a rear surface. And a means to connect and secure the device to a ladder for use with a bucket or the like. An alternative securement means could be a radiused hook device to mechanically support the hanging bucket or the like to the ladder structure.

The accompanying drawings, which are incorporated in and constitute a part of this specification, illustrate a preferred embodiment of the Special ladder hook device 31. The drawings together with the summary description given above and a detailed description given below serve to explain the principles of the Special ladder hook device 31. It is understood, however, that the Special ladder hook device 31 is not limited to only the precise arrangements and instrumentalities shown.

FIGS. 1 A and 1 B are the general views of the actual device—the Special ladder hook device 31, the device securing a bucket or the like to a ladder device. FIG. 1 A shows the device 31 with an encircling section 32, the extension structure 33 and the securement vee 34 to contain the hanging object. In FIG. 1 B a side view of the device 31 shows the same components and features 32, 33, and 34.

FIG. 2 is an isometric sketch of the device with features and components identified. FIG. 2 shows the device 31 with an encircling section 32, the extension structure 33 and the securement vee 34 to contain the hanging object. In FIG. 1 B a side view of the device 31 shows the same components and features 32, 33, and 34. The entire device 31 anticipates the use and compatibility with various materials. The device 31 needs and requires a durable material such as a metal (steel, brass, aluminum and the like), a composite material (plastic, fiber and the like), and wood. Other un-named materials will also be anticipated within the spirit and scope of the Special ladder hook device.

FIG. 3 A is a sketch of the device for its insertion into the ladder. Here the extension means 35 is shown with the other features 32, 33, and 34.

FIG. 4 is an alternative embodiment of the Special ladder hook device. Sown here with the alternative device 31A is a radiused extension 38 for securing the object such as a bucket 50 [not shown] or the like.

All of the details mentioned here are exemplary and not limiting. Other components specific to describing a Special ladder hook device 31 may be added as a person having ordinary skill in the field of ladder hook devices and the presentation of materials for work areas well appreciates.

### OPERATION OF THE PREFERRED EMBODIMENT

The preferred embodiment for the Special ladder hook device 31 has been described in the above paragraphs. The manner of how the device operates is described below. One skilled in the art of ladder hook devices and the like for work areas will note that the description above and the operation described here must be taken together to fully illustrate the concept of the Special ladder hook device 31.

The preferred embodiment of the Special ladder hook device is comprised of a hooking means with features made of a durable, flat and flexible material and having a front and a rear surface. And a means to connect and secure the device to a ladder for use with a bucket or the like. An alternative securement means could be a radiused hook device to mechanically support the hanging bucket or the like to the ladder structure.

FIGS. 3 B and 5 A and 5 B are the general views of the operation. FIG. 3 B is a sketch of the device and its insertion into the ladder. Here in this view the extension 35 is inserted interiorally to the ladder rung 41 to secure the device 31. The device is placed through the ladder side rail 42 into the rung interior 41. The device may be a solid dowel or tubular extension made of durable materials such as, but not limited to, a metal (steel, brass, aluminum and the like), a composite material (plastic, fiber and the like), and wood.

FIGS. 5 A and 5 B are operational views of the Special ladder hook device with the ladder. Here the ladder 45 has the device 31 placed within—as described in FIG. 3 B and the said device 31 supports the bucket 50 or the like.

With the above description it is to be understood that the Special ladder hook device 31 is not to be limited to only the disclosed embodiment. The features of the Special ladder hook device 31 are intended to cover various modifications and equivalent arrangements included within the spirit and scope of the description.

What is claimed is:

1. A Special ladder hook device comprised of
(a) a hooking means with features made of a durable, flat and flexible material and having a front and a rear surface; and
(b) a means for connecting and securing the device to a ladder for use with a bucket or the like
wherein the special ladder hook device may be used to provide a means to secure and support a bucket or the like on a ladder.

2. The device according to claim 1 wherein the durable material is a metal.

3. The device according to claim 2 wherein the metal is steel.

4. The device according to claim 3 wherein the steel is an alloy steel.

5. The device according to claim 2 wherein the metal is aluminum.

6. The device according to claim 2 wherein the metal is brass.

7. The device according to claim 1 wherein the durable material is a composite material.

8. The device according to claim 7 wherein the composite material is a plastic.

9. The device according to claim 1 wherein the hooking means is a “vee” shaped strap.

10. The device according to claim 1 wherein the hooking means is a radiused-shaped strap.

11. The device according to claim 1 wherein the means for connecting and securing is an elongated solid dowel made of durable material.

12. The device according to claim 1 wherein the means for connecting and securing is an elongated tubular structure made of durable material.
